(19) United States
(12) Patent Application Publication
(10) Pub. No.: US 2025/0164408 A1
(43) Pub. Date: May 22, 2025

(54) POSITION FEEDBACK SENSOR USING OUT-OF-BAND WAVELENGTHS

(71) Applicant: KLA CORPORATION, Milpitas, CA (US)

(72) Inventors: Florian Melsheimer, Cologne (DE); Lauren Wilson, San Jose, CA (US); Alon Rosenthal, Weston, CT (US); Matthew Hoffman, Los Altos, CA (US)

(21) Appl. No.: 18/941,459

(22) Filed: Nov. 8, 2024

Related U.S. Application Data
(60) Provisional application No. 63/601,232, filed on Nov. 21, 2023.
(60) Provisional application No. 63/678,893, filed on Aug. 2, 2024.

(51) Int. Cl. G01N 21/88; G01J 1/44; G01N 21/01; G02B 26/08; G05D 3/12

(52) U.S. Cl. CPC G01N 21/8806; G01J 1/44; G01N 21/01; G02B 26/0808; G02B 26/0816; G05D 3/12; G01J 2001/446; G01N 2021/0106; G01N 2201/061; G01N 2201/127

(57) ABSTRACT

An assembly is in a path of a beam of light, which has a first and second spectral components at different wavelengths. A first spectral component and a second spectral component of the beam of light are projected through an aperture. A sensor is disposed around the aperture to only receive a second spectral component of the beam of light. A position of the beam of light relative to the aperture can be determined using information from the sensor.

### CROSS-REFERENCE TO RELATED APPLICATIONS

This application claims priority to the provisional patent application filed Nov. 21, 2023 and assigned U.S. App. No. 63/601,232 and to the provisional patent application filed Aug. 2, 2024 and assigned U.S. App. No. 63/678,893, the disclosures of which are hereby incorporated by reference.

### FIELD OF THE DISCLOSURE

This disclosure relates to position feedback for an optical system.

### BACKGROUND OF THE DISCLOSURE

Evolution of the semiconductor manufacturing industry is placing greater demands on yield management and, in particular, on metrology and inspection systems. Critical dimensions continue to shrink, yet the industry needs to decrease time for achieving high-yield, high-value production. Minimizing the total time from detecting a yield problem to fixing it maximizes the return-on-investment for a semiconductor manufacturer.

Fabricating semiconductor devices, such as logic and memory devices, typically includes processing a specimen like a semiconductor wafer using a large number of fabrication processes to form various features and multiple levels of the semiconductor devices. For example, lithography is a semiconductor fabrication process that involves transferring a pattern from a reticle to a photoresist arranged on a semiconductor wafer. Additional examples of semiconductor fabrication processes include, but are not limited to, chemical-mechanical polishing (CMP), etching, deposition, and ion implantation. An arrangement of multiple semiconductor devices fabricated on a single semiconductor wafer may be separated into individual semiconductor devices.

Inspection processes are used at various steps during semiconductor manufacturing to detect defects on wafers to promote higher yield in the manufacturing process and, thus, higher profits. Inspection has always been an important part of fabricating semiconductor devices such as integrated circuits (ICs). However, as the dimensions of semiconductor devices decrease, inspection becomes even more important to the successful manufacture of acceptable semiconductor devices because smaller defects can cause the devices to fail. For instance, as the dimensions of semiconductor devices decrease, detection of defects of decreasing size has become necessary because even relatively small defects may cause unwanted aberrations in the semiconductor devices.

Defect review typically involves re-detecting defects that were detected by an inspection process and generating additional information about the defects at a higher resolution using either a high magnification optical system or a scanning electron microscope (SEM). Defect review is typically performed at discrete locations on specimens where defects have been detected during inspection. The higher resolution data for the defects generated by defect review is more suitable for determining attributes of the defects such as profile, roughness, or more accurate size information.

Metrology processes are also used at various steps during semiconductor manufacturing to monitor and control the process. Metrology processes are different than inspection processes in that, unlike inspection processes in which defects are detected on specimens, metrology processes are used to measure one or more characteristics of the wafers that cannot be determined using existing inspection tools. Metrology processes can be used to measure one or more characteristics of wafers such that the performance of a process can be determined from the one or more characteristics. For example, metrology processes can measure a dimension (e.g., line width, thickness, etc.) of features formed on the wafers during the process. In addition, if the one or more characteristics of the wafers are unacceptable (e.g., out of a predetermined range for the characteristic(s)), the measurements of the one or more characteristics of the wafers may be used to alter one or more parameters of the process such that additional wafers manufactured by the process have acceptable characteristic(s).

Many inspection, review, and metrology processes use systems that produce in-band light (IB) and out-of-band light (OOB). The IB light may be the spectral component of interest and OOB light includes all other wavelengths present in the beam of light. The IB light is typically used by a down-stream apparatus (e.g., an inspection or exposure tool). OOB light is typically not used or is actively suppressed.

Previously, IB light was used to determine the position of the overall beam of light. However, any IB light that is used for positional feedback is subtracted from the main beam, which means it cannot be used for any downstream application. This reduces throughput. IB light also may include high energy photons. These high energy photons can degrade a sensor over time. In addition, it can be difficult or expensive to find beam splitters or other optical components for certain wavelengths of IB light to enable determination of beam position.

Attempts were previously made to minimize the amount of IB light used for positional feedback, which minimized the effect on throughput. However, the quality of the feedback was reduced because the center of the beam of light and the periphery of the beam of light may not be well-correlated. Minor changes to the beam profile could result in large feedback errors.

Therefore, improved systems and techniques are needed.

### BRIEF SUMMARY OF THE DISCLOSURE

A system is provided in a first embodiment. The system includes an assembly in a path of a beam of light. The assembly defines an aperture in the assembly. A first spectral component and a second spectral component of the beam of light are projected through the aperture. The first spectral component and the second spectral components have different wavelengths. A sensor defines four sensor sections disposed around the aperture. The sensor is positioned to primarily or only receive a second spectral component of the beam of light. A processor is in electronic communication with the sensor. The processor is configured to determine a position of the beam of light relative to the aperture using information from the sensor.

The system may include a plasma light source that generates the light.

The sensor sections each may be a photodiode, a photocathode, or a thermocouple.

Each of the sensor sections may be disposed on the assembly adjacent to the aperture.

The system may include reflective elements disposed on the assembly adjacent to the aperture. Each of the reflective elements reflects the part of the second spectral component to a corresponding one of the sensor sections.

The system may include a diffractive element disposed in a path of the beam of light. The diffractive element directs the first spectral component through the aperture and the part of the second spectral component to the sensor sections.

The first spectral component may have a wavelength of 13.5 nm.

The second spectral component may have a longer wavelength than the first spectral component.

The first spectral component may be inside the second spectral component.

A method is provided in a second embodiment. The method includes directing a beam of light at an aperture of an assembly. The beam of light includes a first spectral component and a second spectral component. At least the first spectral component is directed through the aperture. The first spectral component and the second spectral component have different wavelengths. Primarily or only the second spectral component is received at a plurality of sensor sections. Using a processor, a position of the beam of light relative to the aperture is determined using information from the sensor sections.

The method can include generating the beam of light with a plasma light source.

The sensor sections each may be a photodiode, a photocathode, or a thermocouple.

Each of the sensor sections may be disposed on the assembly adjacent to the aperture.

The method can include reflecting part of the second spectral component to the sensor sections with a plurality of reflective elements. The plurality of reflective elements can be disposed on the assembly adjacent to the aperture.

The method may include diffracting the beam of light using a diffractive element disposed in a path of the beam of light thereby directing the first spectral component through the aperture and the part of the second spectral component to the sensor sections.

The first spectral component may have a wavelength of 13.5 nm.

The second spectral component may have a longer wavelength than the first spectral component.

The first spectral component may be inside the second spectral component.

### DESCRIPTION OF THE DRAWINGS

For a fuller understanding of the nature and objects of the disclosure, reference should be made to the following detailed description taken in conjunction with the accompanying drawings, in which:

FIG. 1 is a cross-sectional side view of an embodiment of a system in accordance with the present disclosure;

FIG. 2 is a top view of the embodiment shown in FIG. 1;

FIG. 3 is a cross-sectional side view of another embodiment of a system in accordance with the present disclosure;

FIG. 4 is a cross-sectional side view of another embodiment of a system in accordance with the present disclosure;

FIG. 5 is a flowchart of a method in accordance with the present disclosure; and

FIG. 6 is a block diagram of another system in accordance with the present disclosure.

### DETAILED DESCRIPTION OF THE DISCLOSURE

Although claimed subject matter will be described in terms of certain embodiments, other embodiments, including embodiments that do not provide all of the benefits and features set forth herein, are also within the scope of this disclosure. Various structural, logical, process step, and electronic changes may be made without departing from the scope of the disclosure. Accordingly, the scope of the disclosure is defined only by reference to the appended claims.

Embodiments disclosed herein include an OOB-sensitive position feedback sensor that can be placed in-line or off-axis from the optical beam axis for in-situ position measurement of the beam of light. OOB light can be used to generate positional feedback to control a position of the IB light component. Positional feedback can be provided to actively stabilize position of the beam of light. This enables utilization of closer to 100% of IB light for the intended application, while still providing positional feedback. Furthermore, different sensor and sampling technologies can be used with OOB light compared to IB sampling. This provides more design options and can result in a more reliable system. In an instance, no IB light is lost to gain positional feedback and achieve active stabilization of the beam of light, which can maximize optical system efficiency and throughput.

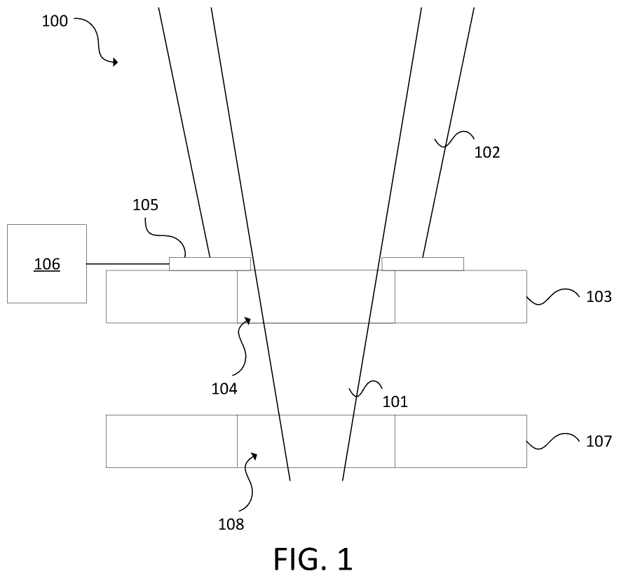

FIG. 1 is a cross-sectional side view of an embodiment of a system 100. An assembly 103 is in a path of a beam of light. The beam of light includes a first spectral component 101 and a second spectral component 102. The first spectral component 101 may be IB light. The IB light may be the spectral component of interest, such as 13.5 nm for an extreme ultraviolet (EUV) system. The second spectral component 102 may be OOB light. The beam of light with the first spectral component 101 and second spectral component 102 is directed toward the assembly 103 or the aperture 104 defined by the assembly 103.

The beam of light may be generated by a plasma light source. Plasma light sources (e.g., laser or discharge produced plasma light sources) typically emit OOB light with longer wavelength from a larger volume than IB light with shorter wavelength. This effective size difference occurs because the dense and hot core plasma is the source for most short wavelength light, while the expanding colder plasma tends to emit longer wavelength radiation. The expansion of plasma is a dynamic process evolving during and after a laser pulse or discharge, but occurs on the same short time scale. Since the whole pulse is temporally integrated in a typical measurement, the effective source size for OOB light (long wavelength) appears larger than for IB light (short wavelength). If the plasma is expanding from a dense surface like in laser-produced plasma from a solid, the mean position of the OOB source may be further from the surface than the IB source. While size and position of the IB source and OOB source may be different, their positions are still correlated. Under this assumption, a position of the IB light can be deduced from a position of the OOB light because the IB light can be assumed to be at the center of the OOB light.

In an instance, the first spectral component 101 and second spectral component 102 have different wavelengths. The second spectral component 102 may have a longer wavelength and bigger footprint than the first spectral component 101. The first spectral component 101 may be positioned inside or at a center of the second spectral component 102. In an example, the first spectral component 101 may have a wavelength of 13.5 nm and the second spectral component 102 may be visible light. In another example, the first spectral component 101 may be 13-14 nm and the second spectral component may be 14-1030 nm for a laser-produced plasma (LPP) EUV source.

The first spectral component 101 is projected through the aperture 104 in the assembly 103. The aperture 104 passes through an entirety of the assembly 103. The diameter of the first spectral component 101 and/or diameter of the aperture 104 can be configured to enable the first spectral component 101 to pass through the aperture 104. For example, the aperture may be from 0.5×0.5 to 2×2 mm, but the dimensions can vary with the optical system design. 100% or less than 100% of the first spectral component 101 can pass through the aperture 104. In an instance, from 60% to 95% (e.g., 80% to 85%) of the first spectral component 101 can pass through the aperture 104. Some of the second spectral component 102 also can pass through the aperture 104. The aperture 104 may be round, square, rectangular, polygonal, or other shapes.

A sensor 105 only receives the second spectral component 102. Some or all of the second spectral component 102 is received by the sensor 105. In an instance, none of the first spectral component 101 is received by the sensor 105. While singular, the sensor 105 can include multiple sensors 105 or sections of the same sensor 105. The sections of the sensor 105 may be considered as separate sensors 105 because, for example, the sensors 105 may perform independent measurements. In an example, the sensor 105 is approximately 4×4 mm, but the sensor 105 may be other dimensions. The sensor 105 may have dimensions (e.g., diameter) larger than the dimensions of the aperture 104.

In an embodiment, the sensor 105 has multiple sections that are light-sensitive and can generate information for measurements. For example, there may be six to twelve (e.g., eight) sections in the sensor 105. These sections may be, for example, arranged as sectors of a round sensor 105 or as polygons of a polygonal sensor 105. Four sections can determine position of a spot, but eight sections can enable determination whether a shape of the light is elongated or round. Thus, more than four sections may improve accuracy. Each section of the sensor 105 may be a separate channel of the sensor 105. Thus, each section of the sensor 105 can perform an independent measurement.

The second spectral component 102 can have longer wavelength light, so it may have lower photon energy. Depending on the sensor 105, measuring the second spectral component 102 may lead to less degradation of the sensor 105 compared to measuring the first spectral component 101. Also, since the distribution of the second spectral component 102 is broader than the first spectral component 101, a larger portion of the distribution can be sampled at any time. Thus, using the second spectral component 102 for measurements can improve the signal-to-noise ratio, such as for differential signals.

The sensor 105 may be sensitive to both IB and OOB light (i.e., a mixed signal) or may only be sensitive to OOB light. Sensitivity of the sensor 105 to the OOB light in the second spectral component 102 may be provided across a broad band or a distinct narrow band component of the OOB light spectrum. Sensitivity may be a combination of spectral response of the photodiode (e.g., a response curve for a photodiode) and filter coatings applied to a layer of the photodiode that can attenuate particular wavelengths. Each design of the sensor 105 can have a different response to the IB and OOB light. In an embodiment, the sensor 105 is a diode and a filter can be added to a top of the diode that only passes VIS light or a narrow band. An SiC diode may already be sensitive to <400 nm light. Combined with SiO₂ and the sensor may only be sensitive from 200-400 nm. In another embodiment, a photocathode may be sensitive to UV and shorter wavelengths.

In the embodiment of FIG. 1, the sensor 105 is disposed on the assembly 103. The sensor 105 is disposed adjacent to the aperture 104. In an instance, the sensor 105 occludes or blocks part of the aperture 104. The sensor 105 may be around the aperture 104, which allows light to pass.

The sensor 105 can be a multi-cell sensor around the aperture 104. This may be a quad-cell with four sections of the sensor 105 or an octa-cell with eight sections of the sensor 105. Other numbers of sections of the sensor 105 or sensors 105 are possible. The sensor 105 can collect edges of the beam of light, which is primarily or entirely the second spectral component 102. More sensors 105 can improve sensitivity, but four sensors 105 provide enough sensitivity for process control. The sensor 105 can be positioned in light that has an optical axis of the beam of light.

A processor 106 is in electronic communication with the sensor 105. The processor 106 can determine a position of the beam of light relative to the aperture 104 using information from the sensor 105. Signals from the sensor 105 can be processed to provide a position feedback signal. Sensitivity to the second spectral component 102 and band selection can be achieved by selective sensitivity of the sensor 105 or with an additional transmissive band filter.

A target aperture assembly 107 is illustrated in FIG. 1. The target aperture assembly 107 includes a target aperture 108. The target aperture assembly 107 can be an entrance of a homogenizer rod or other optical element. The sensor 105 can help center the light on the target aperture assembly 107 so that a maximized amount of the first spectral component 101 enters the target aperture assembly 107. A virtual aperture also can be used for the target aperture assembly 107, which can reference a location in space that is relevant for the optical system. For critical illumination (i.e., without a homogenizer) tracking a location of the intermediate focus can help stabilize the beam.

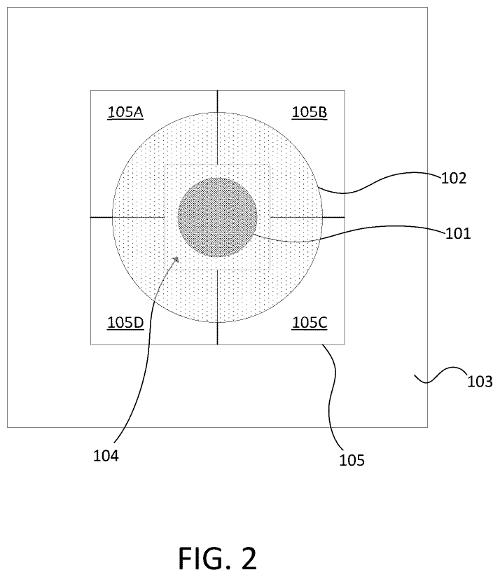

FIG. 2 is a top view of the embodiment shown in FIG. 1. As shown in FIG. 2, the assembly 103 has an aperture 104. In this example, the aperture 104 is square, but an aperture 104 that is round, polygonal, or other shapes is possible. The first spectral component 101 and second spectral component 102 are shown with different shading. The first spectral component 101 passes through the aperture 104. Most of the second spectral component 102 is blocked by the assembly and is received by the sensor 105. The sensor 105 in FIG. 2 includes four sensor sections 105A-105D. These sensor sections 105A-105D extend up to an edge of the aperture 104, but also can overhang the aperture 104 or can be spaced apart from the edge of the aperture 104 to avoid an overhang. Each of the sensor sections 105A-105D can be a photodiode, a photocathode, a thermocouple, or another type of measuring device. The sensor sections 105A-105D also can be areas of a camera that can image visible light. While described as a section of a sensor 105, the sensor sections 105A-105D also can be separate sensors 105.

In an embodiment, measurements from sensor section 105A are compared against sensor section 105C during operation. Then measurements from sensor section 105B are compared against sensor section 105D during operation. If measurements from these pairs of sensor sections 105A-105D are equal, then the beam of light is centered. The first spectral component 101 is assumed to be in a center of the beam of light, so if these pairs of sensor sections 105A-105D capture the same amount of the second spectral component 102 then the beam of light is centered relative to the aperture 104. This allows the first spectral component 101 to be used for measurements downstream instead of using the first spectral component 101 for positional feedback. While described with separate sensor sections 105A-105D, the same will occur with different sensors 105.

In an example, a calculation for horizontal position is ((A+D)−(B+C))/(A+B+C+D) and for vertical position is ((A+B)−(D+C))/(A+B+C+D). A-D refer to measurements from sensor sections 105A-105D, respectively. The calculated signal is the difference in light hitting the left versus right part (or top versus bottom part). If both differences are 0, then the beam is centered.

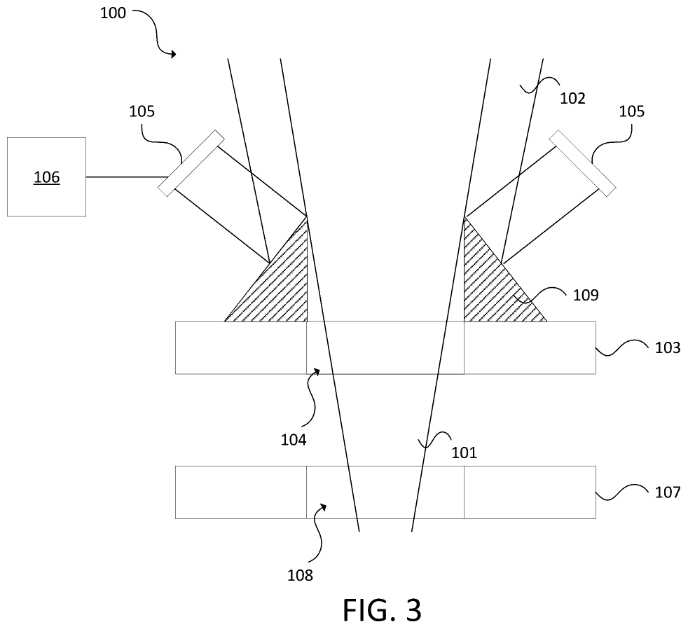

FIG. 3 is a cross-sectional side view of another embodiment of a system 100. The system 100 includes reflective elements 109 disposed on the assembly 103 adjacent to the aperture 104. Each of the reflective elements 109 reflects the second spectral component 102 toward a sensor 105 or one of the sensors 105. The reflective elements 109 may be placed at a same location as the sensors 105 in FIG. 1. If a reflective surface of the reflective elements 109 in FIG. 3 is angled outward, then light hitting the reflective elements 109 will be reflected off-axis. The reflective elements 109 can be selectively reflective to certain OOB bands at opposing edges of the beam of light. The reflective elements 109 may be a solid mirror or can have a single or multilayer coating of materials. The sensors 105 can be positioned to receive the reflected second spectral component 102 that is diverted using the reflective elements 109. The system 100 of FIG. 3 provides off-axis sampling of the second spectral component 102. In an instance, the reflective elements 109 may act as a spectral filter such that the reflective element 109 is not reflective for high-energy photons. This can protect the sensor or sensors 105 from unnecessary exposure to these high-energy photons. The spectral filter can be a coating or can include material selection for the reflective elements 109. For example, polished aluminum will not reflect EUV at a large incident angle, but this may only apply to ultraviolet-visible (UV-VIS) light. In another example, gold can reflect more visible light than ultraviolet (UV) light.

While two reflective elements 109 are shown in FIG. 3, a single reflective element 109 that wraps around the aperture 104 can be used.

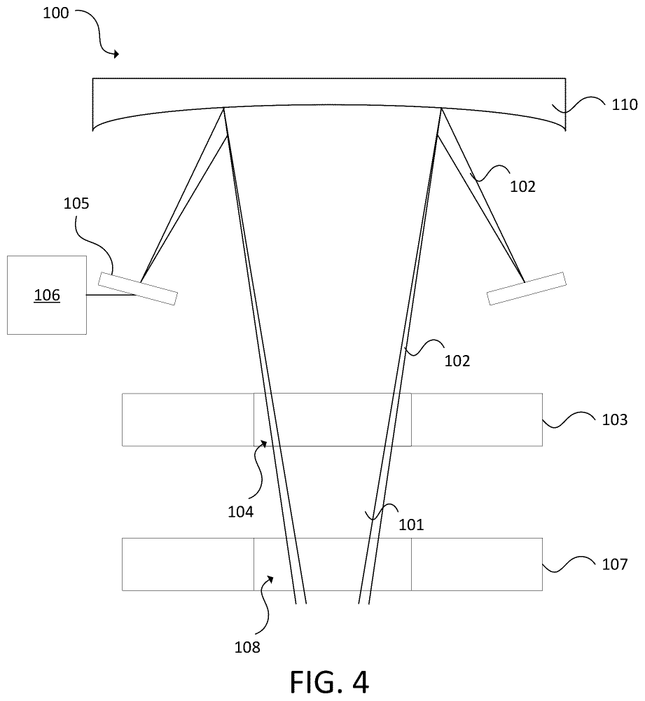

FIG. 4 is a cross-sectional side view of another embodiment of a system 100. A diffractive element 110 is positioned in a path of the first spectral component 101 and the second spectral component 102. The diffractive element 110 directs the first spectral component 101 through the aperture 104 of the assembly 103. The diffractive element 110 directs some or all of the second spectral component 102 to the sensor or sensors 105. The sensor or sensors 105 can be positioned to receive the reflected second spectral component 102.

The diffractive element 110 can be a mirror that is upstream of the target aperture assembly 107. The diffractive element 110 can include features like a diffractive grating or multiple small gratings, which can disperse OOB light at an angle relative to the main beam of light. The gratings can be etched or deposited on a surface of the diffractive element 110 and can diffract light into higher orders (i.e., different angles). This can enable the sensor or sensors 105 to be placed off-axis, which separates the sensor or sensors 105 from the position of interest. The diffractive grating can perform first order diffraction and redirect certain wavelengths of light. The diffractive grating also can diffract light away from an axis to filter the light for downstream applications.

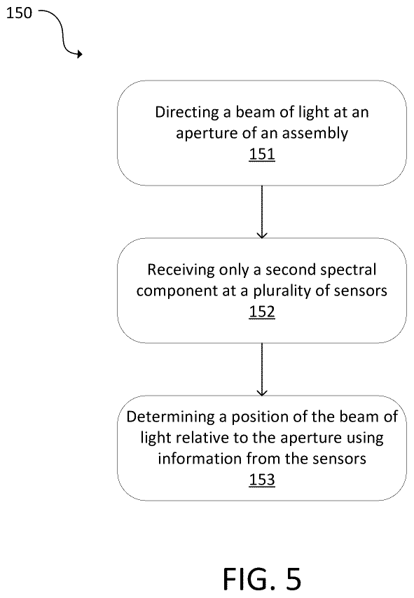

Embodiments disclosed herein can provide positional feedback of the second spectral component 102. Assuming that average IB and OOB source positions are correlated, a position of the IB light can be determined. FIG. 5 is a flowchart of a method 150. The method 150 can use an embodiment of the system 100, such as those illustrated in FIGS. 1-4.

In FIG. 5, a beam of light is directed at an aperture of an assembly at 151. The beam of light includes a first spectral component and a second spectral component. The beam of light may be generated with, for example, a plasma light source. At least the first spectral component is directed through the aperture. At 152, only the second spectral component is received at the sensor or sensors. This may be some or all of the second spectral component. The sensor or sensors may each be a photodiode, a photocathode, a thermocouple, or another type of sensor. Using a processor, a position of the beam of light relative to the aperture is determined using information from the sensor or sensors at 153. The processor also can send instructions to adjust a position of the beam of light based on the position of the beam of light that is determined. For example, a position of a mirror or another optical component can be adjusted upstream of the system 100. The position may be adjusted until, for example, a center of the beam of light is projected through a center of the aperture, the measurements of the sensor or sensors are equal, and/or the majority of the first spectral component is projected through the aperture. Other adjustments are possible, and these are merely examples.

The sensor or sensors can be positioned in different configurations. As shown in FIG. 1, the sensor or sensors can be disposed on the assembly adjacent the aperture. As shown in FIG. 3, part of the second spectral component can be reflected to the sensor or sensors with reflective elements that are disposed on the assembly adjacent the aperture. As shown in FIG. 4, the beam of light can be diffracted using a diffractive element disposed in a path of the beam of light. The diffractive element can direct the first spectral component through the aperture and part of the second spectral component to the sensor or sensors.

In an embodiment, in-band degradation can be tracked upstream. The light level of the beam of light can be tracked over time. Since an OOB sensor can track longer OOB wavelengths (e.g., up to approximately 1100 nm if Si-based) instead of short EUV wavelengths, the sensor will suffer less photo-degradation and carbon contamination on its surface over time. For example, outer edges or areas of the sensor surfaces away from the nominal operating point can receive reduced degradation due to the longer wavelengths (e.g., beyond VUV and UV) and reduced dose. In an instance, the EUV beam can be steered to these areas of reduced degradation on a periodic basis, such as weekly or monthly. This can enable measurement of degradation of the upstream optics over time in the EUV regime. Such measurement can be further improved if a spectral purity filter is used to ensure that only in-band EUV light is received by the sensor for this degradation measurement. Insertion loss from the spectral purity filter can be determined downstream by comparing data with and without the spectral purity filter.

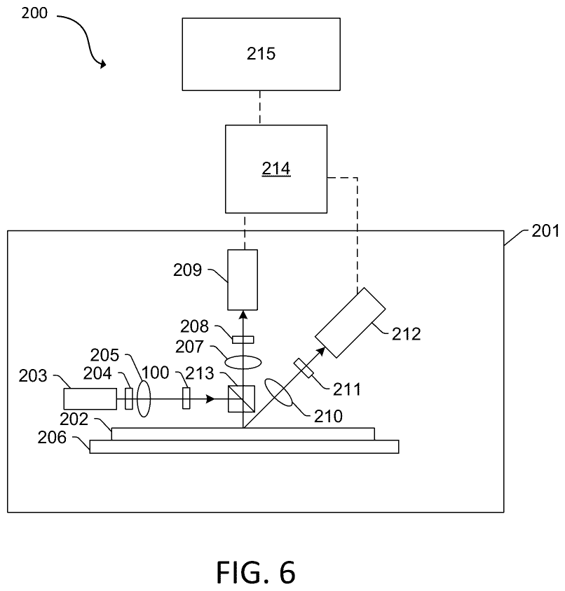

An embodiment of a system 200 is shown in FIG. 6. The system 200 includes optical based subsystem 201. In general, the optical based subsystem 201 is configured for generating optical based output for a specimen 202 by directing light to (or scanning light over) and detecting light from the specimen 202. In one embodiment, the specimen 202 includes a wafer. The wafer may include any wafer known in the art. In another embodiment, the specimen 202 includes a reticle. The reticle may include any reticle known in the art.

In the embodiment of the system 200 shown in FIG. 6, optical based subsystem 201 includes an illumination subsystem configured to direct light to specimen 202. The illumination subsystem includes at least one light source. For example, as shown in FIG. 6, the illumination subsystem includes light source 203. In one embodiment, the illumination subsystem is configured to direct the light to the specimen 202 at one or more angles of incidence, which may include one or more oblique angles and/or one or more normal angles. For example, as shown in FIG. 6, light from light source 203 is directed through optical element 204 and then lens 205 to specimen 202 at an oblique angle of incidence. The oblique angle of incidence may include any suitable oblique angle of incidence, which may vary depending on, for instance, characteristics of the specimen 202.

The optical based subsystem 201 may be configured to direct the light to the specimen 202 at different angles of incidence at different times. For example, the optical based subsystem 201 may be configured to alter one or more characteristics of one or more elements of the illumination subsystem such that the light can be directed to the specimen 202 at an angle of incidence that is different than that shown in FIG. 6. In one such example, the optical based subsystem 201 may be configured to move light source 203, optical element 204, and lens 205 such that the light is directed to the specimen 202 at a different oblique angle of incidence or a normal (or near normal) angle of incidence.

In some instances, the optical based subsystem 201 may be configured to direct light to the specimen 202 at more than one angle of incidence at the same time. For example, the illumination subsystem may include more than one illumination channel, one of the illumination channels may include light source 203, optical element 204, and lens 205 as shown in FIG. 6 and another of the illumination channels (not shown) may include similar elements, which may be configured differently or the same, or may include at least a light source and possibly one or more other components such as those described further herein. If such light is directed to the specimen at the same time as the other light, one or more characteristics (e.g., wavelength, polarization, etc.) of the light directed to the specimen 202 at different angles of incidence may be different such that light resulting from illumination of the specimen 202 at the different angles of incidence can be discriminated from each other at the detector(s). The optical based subsystem 201 also can include an embodiment of the system 100. The system 100 is shown in FIG. 6 as downstream of the optical element 204 and lens 205, but other placements in the system 200 are possible.

In another instance, the illumination subsystem may include only one light source (e.g., light source 203 shown in FIG. 6) and light from the light source may be separated into different optical paths (e.g., based on wavelength, polarization, etc.) by one or more optical elements (not shown) of the illumination subsystem. Light in each of the different optical paths may then be directed to the specimen 202. Multiple illumination channels may be configured to direct light to the specimen 202 at the same time or at different times (e.g., when different illumination channels are used to sequentially illuminate the specimen). In another instance, the same illumination channel may be configured to direct light to the specimen 202 with different characteristics at different times. For example, in some instances, optical element 204 may be configured as a spectral filter and the properties of the spectral filter can be changed in a variety of different ways (e.g., by swapping out the spectral filter) such that different wavelengths of light can be directed to the specimen 202 at different times. The illumination subsystem may have any other suitable configuration known in the art for directing the light having different or the same characteristics to the specimen 202 at different or the same angles of incidence sequentially or simultaneously.

In one embodiment, light source 203 may include a broadband plasma (BBP) source. In this manner, the light generated by the light source 203 and directed to the specimen 202 may include broadband light. However, the light source may include any other suitable light source such as, but not limited to, a laser. The laser may include any suitable laser known in the art and may be configured to generate light at any suitable wavelength or wavelengths known in the art. In addition, the laser may be configured to generate light that is monochromatic or nearly-monochromatic. In this manner, the laser may be a narrowband laser. The light source 203 may also include a polychromatic light source that generates light at multiple discrete wavelengths or wavebands.

A BBP source is a light source 203 that excites a plasma, such as a Xe plasma using a 1028 nm laser pulse. After this plasma is excited, a short burst of light is produced that contains many wavelengths from the in-band EUV (13 to 14 nm) to 1-micron wavelengths (e.g., some of the original laser light used to excite). Other conditions for the Xe plasma are possible, which can produce different wavelengths (e.g., 100-200 nm).

Light from optical element 204 may be focused onto specimen 202 by lens 205. Although lens 205 is shown in FIG. 6 as a single refractive optical element, it is to be understood that, in practice, lens 205 may include a number of refractive and/or reflective optical elements that in combination focus the light from the optical element to the specimen. The illumination subsystem shown in FIG. 6 and described herein may include any other suitable optical elements (not shown). Examples of such optical elements include, but are not limited to, polarizing component(s), spectral filter(s), spatial filter(s), reflective optical element(s), apodizer(s), beam splitter(s) (such as beam splitter 213), aperture(s), and the like, which may include any such suitable optical elements known in the art. In addition, the optical based subsystem 201 may be configured to alter one or more of the elements of the illumination subsystem based on the type of illumination to be used for generating the optical based output.

The optical based subsystem 201 may also include a scanning subsystem configured to cause the light to be scanned over the specimen 202. For example, the optical based subsystem 201 may include stage 206 on which specimen 202 is disposed during optical based output generation. The scanning subsystem may include any suitable mechanical and/or robotic assembly (that includes stage 206) that can be configured to move the specimen 202 such that the light can be scanned over the specimen 202. In addition, or alternatively, the optical based subsystem 201 may be configured such that one or more optical elements of the optical based subsystem 201 perform scanning of the light over the specimen 202. The light may be scanned over the specimen 202 in any suitable fashion such as in a serpentine-like path or in a spiral path.

The optical based subsystem 201 further includes one or more detection channels. At least one of detection channels includes a detector configured to detect light from the specimen 202 due to illumination of the specimen 202 by the subsystem and to generate output responsive to the detected light. For example, the optical based subsystem 201 shown in FIG. 6 includes two detection channels, one formed by collector 207, element 208, and detector 209 and another formed by collector 210, element 211, and detector 212. As shown in FIG. 6, the two detection channels are configured to collect and detect light at different angles of collection. In some instances, both detection channels are configured to detect scattered light, and the detection channels are configured to detect light that is scattered at different angles from the specimen 202. However, one or more of the detection channels may be configured to detect another type of light from the specimen 202 (e.g., reflected light).

As further shown in FIG. 6, both detection channels are shown positioned in the plane of the paper and the illumination subsystem is also shown positioned in the plane of the paper. Therefore, in this embodiment, both detection channels are positioned in (e.g., centered in) the plane of incidence. However, one or more of the detection channels may be positioned out of the plane of incidence. For example, the detection channel formed by collector 210, element 211, and detector 212 may be configured to collect and detect light that is scattered out of the plane of incidence. Therefore, such a detection channel may be commonly referred to as a “side” channel, and such a side channel may be centered in a plane that is substantially perpendicular to the plane of incidence.

Although FIG. 6 shows an embodiment of the optical based subsystem 201 that includes two detection channels, the optical based subsystem 201 may include a different number of detection channels (e.g., only one detection channel or two or more detection channels). In one such instance, the detection channel formed by collector 210, element 211, and detector 212 may form one side channel as described above, and the optical based subsystem 201 may include an additional detection channel (not shown) formed as another side channel that is positioned on the opposite side of the plane of incidence. Therefore, the optical based subsystem 201 may include the detection channel that includes collector 207, element 208, and detector 209 and that is centered in the plane of incidence and configured to collect and detect light at scattering angle(s) that are at or close to normal to the specimen 202 surface. This detection channel may therefore be commonly referred to as a “top” channel, and the optical based subsystem 201 may also include two or more side channels configured as described above. As such, the optical based subsystem 201 may include at least three channels (i.e., one top channel and two side channels), and each of the at least three channels has its own collector, each of which is configured to collect light at different scattering angles than each of the other collectors.

As described further above, each of the detection channels included in the optical based subsystem 201 may be configured to detect scattered light. Therefore, the optical based subsystem 201 shown in FIG. 6 may be configured for dark field (DF) output generation for specimens 202. However, the optical based subsystem 201 may also or alternatively include detection channel(s) that are configured for bright field (BF) output generation for specimens 202. In other words, the optical based subsystem 201 may include at least one detection channel that is configured to detect light specularly reflected from the specimen 202. Therefore, the optical based subsystems 201 described herein may be configured for only DF, only BF, or both DF and BF imaging. Although each of the collectors are shown in FIG. 6 as single refractive optical elements, it is to be understood that each of the collectors may include one or more refractive optical die(s) and/or one or more reflective optical element(s).

The one or more detection channels may include any suitable detectors known in the art. For example, the detectors may include photo-multiplier tubes (PMTs), charge coupled devices (CCDs), time delay integration (TDI) cameras, and any other suitable detectors known in the art. The detectors may also include non-imaging detectors or imaging detectors. In this manner, if the detectors are non-imaging detectors, each of the detectors may be configured to detect certain characteristics of the scattered light such as intensity but may not be configured to detect such characteristics as a function of position within the imaging plane. As such, the output that is generated by each of the detectors included in each of the detection channels of the optical based subsystem may be signals or data, but not image signals or image data. In such instances, a processor such as processor 214 may be configured to generate images of the specimen 202 from the non-imaging output of the detectors. However, in other instances, the detectors may be configured as imaging detectors that are configured to generate imaging signals or image data. Therefore, the optical based subsystem may be configured to generate optical images or other optical based output described herein in a number of ways.

It is noted that FIG. 6 is provided herein to generally illustrate a configuration of an optical based subsystem 201 that may be included in the system embodiments described herein or that may generate optical based output that is used by the system embodiments described herein. The optical based subsystem 201 configuration described herein may be altered to optimize the performance of the optical based subsystem 201 as is normally performed when designing a commercial output acquisition system. In addition, the systems described herein may be implemented using an existing system (e.g., by adding functionality described herein to an existing system). For some such systems, the methods described herein may be provided as optional functionality of the system (e.g., in addition to other functionality of the system). Alternatively, the system described herein may be designed as a completely new system.

The processor 214 may be coupled to the components of the system 200 in any suitable manner (e.g., via one or more transmission media, which may include wired and/or wireless transmission media) such that the processor 214 can receive output. The processor 214 may be configured to perform a number of functions using the output and may be the same as processor 106 or used in conjunction with processor 106. The system 200 can receive instructions or other information from the processor 214. The processor 214 and/or the electronic data storage unit 215 optionally may be in electronic communication with a wafer inspection tool, a wafer metrology tool, or a wafer review tool (not illustrated) to receive additional information or send instructions. For example, the processor 214 and/or the electronic data storage unit 215 can be in electronic communication with a scanning electron microscope.

The processor 214 (and/or processor 106), other system(s), or other subsystem(s) described herein may be part of various systems, including a personal computer system, image computer, mainframe computer system, workstation, network appliance, internet appliance, or other device. The subsystem(s) or system(s) may also include any suitable processor known in the art, such as a parallel processor. In addition, the subsystem(s) or system(s) may include a platform with high-speed processing and software, either as a standalone or a networked tool.

The processor 214 and electronic data storage unit 215 may be disposed in or otherwise part of the system 200 or another device. In an example, the processor 214 and electronic data storage unit 215 may be part of a standalone control unit or in a centralized quality control unit. Multiple processors 214 or electronic data storage units 215 may be used.

The processor 214 may be implemented in practice by any combination of hardware, software, and firmware. Also, its functions as described herein may be performed by one unit, or divided up among different components, each of which may be implemented in turn by any combination of hardware, software and firmware. Program code or instructions for the processor 214 to implement various methods and functions may be stored in readable storage media, such as a memory in the electronic data storage unit 215 or other memory.

If the system 200 includes more than one processor 214, then the different subsystems may be coupled to each other such that images, data, information, instructions, etc. can be sent between the subsystems. For example, one subsystem may be coupled to additional subsystem(s) by any suitable transmission media, which may include any suitable wired and/or wireless transmission media known in the art. Two or more of such subsystems may also be effectively coupled by a shared computer-readable storage medium (not shown).

The processor 214 may be configured to perform a number of functions using the output of the system 200 or other output. For instance, the processor 214 may be configured to send the output to an electronic data storage unit 215 or another storage medium. The processor 214 may be configured according to any of the embodiments described herein. The processor 214 also may be configured to perform other functions or additional steps using the output of the system 200 or using images or data from other sources.

Various steps, functions, and/or operations of system 200 and the methods disclosed herein are carried out by one or more of the following: electronic circuits, logic gates, multiplexers, programmable logic devices, ASICs, analog or digital controls/switches, microcontrollers, or computing systems. Program instructions implementing methods such as those described herein may be transmitted over or stored on carrier medium. The carrier medium may include a storage medium such as a read-only memory, a random access memory, a magnetic or optical disk, a non-volatile memory, a solid state memory, a magnetic tape, and the like. A carrier medium may include a transmission medium such as a wire, cable, or wireless transmission link. For instance, the various steps described throughout the present disclosure may be carried out by a single processor 214 or, alternatively, multiple processors 214. Moreover, different sub-systems of the system 200 may include one or more computing or logic systems. Therefore, the above description should not be interpreted as a limitation on the present disclosure but merely an illustration.

In an instance, the processor 214 is in communication with the system 200. The processor 214 is configured to any of the methods disclosed herein, including the method 150.

An additional embodiment relates to a non-transitory computer-readable medium storing program instructions executable on a controller for performing a computer-implemented method for determining a position of a beam of light, as disclosed herein. In particular, as shown in FIG. 6, electronic data storage unit 215 or other storage medium may contain non-transitory computer-readable medium that includes program instructions executable on the processor 214. The computer-implemented method may include any step(s) of any method(s) described herein, including method 150.

The program instructions may be implemented in any of various ways, including procedure-based techniques, component-based techniques, and/or object-oriented techniques, among others. For example, the program instructions may be implemented using ActiveX controls, C++ objects, JavaBeans, Microsoft Foundation Classes (MFC), Streaming SIMD Extension (SSE), or other technologies or methodologies, as desired.

Each of the steps of the method may be performed as described herein. The methods also may include any other step(s) that can be performed by the processor and/or computer subsystem(s) or system(s) described herein. The steps can be performed by one or more computer systems, which may be configured according to any of the embodiments described herein. In addition, the methods described above may be performed by any of the system embodiments described herein.

Although the present disclosure has been described with respect to one or more particular embodiments, it will be understood that other embodiments of the present disclosure may be made without departing from the scope of the present disclosure. Hence, the present disclosure is deemed limited only by the appended claims and the reasonable interpretation thereof.

What is claimed is:

1. A system comprising:
an assembly in a path of a beam of light, wherein the assembly defines an aperture in the assembly, wherein a first spectral component and a second spectral component of the beam of light are projected through the aperture, and wherein the first spectral component and the second spectral component have different wavelengths;
a sensor that defines four sensor sections disposed around the aperture, wherein the sensor is positioned to primarily receive a second spectral component of the beam of light; and
a processor in electronic communication with the sensor, wherein the processor is configured to determine a position of the beam of light relative to the aperture using information from the sensor.

2. The system of claim 1, further comprising a plasma light source that generates the light.

3. The system of claim 1, wherein the sensor sections are each a photodiode, a photocathode, or a thermocouple.

4. The system of claim 1, wherein each of the sensor sections is disposed on the assembly adjacent to the aperture.

5. The system of claim 1, further comprising a plurality of reflective elements disposed on the assembly adjacent to the aperture, wherein each of the reflective elements reflects the part of the second spectral component to a corresponding one of the sensor sections.

6. The system of claim 1, further comprising a diffractive element disposed in a path of the beam of light, wherein the diffractive element directs the first spectral component through the aperture and the part of the second spectral component to the sensor sections.

7. The system of claim 1, wherein the first spectral component has a wavelength of 13.5 nm.

8. The system of claim 1, wherein the second spectral component has a longer wavelength than the first spectral component.

9. The system of claim 1, wherein the first spectral component is inside the second spectral component.

10. A method comprising:
directing a beam of light at an aperture of an assembly, wherein the beam of light includes a first spectral component and a second spectral component, and wherein at least the first spectral component is directed through the aperture, wherein the first spectral component and the second spectral component have different wavelengths;
receiving primarily the second spectral component at a plurality of sensor sections; and
determining, using a processor, a position of the beam of light relative to the aperture using information from the sensor sections.

11. The method of claim 10, further comprising generating the beam of light with a plasma light source.

12. The method of claim 10, wherein the sensor sections are each a photodiode, a photocathode, or a thermocouple.

13. The method of claim 10, wherein each of the sensor sections is disposed on the assembly adjacent to the aperture.

14. The method of claim 10, further comprising reflecting part of the second spectral component to the sensor sections with a plurality of reflective elements, wherein the plurality of reflective elements are disposed on the assembly adjacent to the aperture.

15. The method of claim 10, further comprising diffracting the beam of light using a diffractive element disposed in a path of the beam of light thereby directing the first spectral component through the aperture and the part of the second spectral component to the sensor sections.

16. The method of claim 10, wherein the first spectral component has a wavelength of 13.5 nm.

17. The method of claim 10, wherein the second spectral component has a longer wavelength than the first spectral component.

18. The method of claim 10, further comprising sending instructions, using the processor, to adjust a position of the beam of light based on the position.
